(19) United States
(12) Patent Application Publication
(10) Pub. No.: US 2025/0304397 A1
(43) Pub. Date: Oct. 2, 2025

(54) SWITCHING GATE AND MEDIUM PROCESSING DEVICE

(71) Applicant: Oki Electric Industry Co., Ltd., Tokyo (JP)

(72) Inventors: Madoka WAKABAYASHI, Tokyo (JP); Kazuhiro HOSOKAWA, Tokyo (JP)

(73) Assignee: Oki Electric Industry Co., Ltd., Tokyo (JP)

(21) Appl. No.: 18/865,510

(22) PCT Filed: Jul. 3, 2023
(86) PCT No.: PCT/JP2023/024694

§ 371 Date: Nov. 13, 2024

(30) Foreign Application Priority Data
Aug. 25, 2022 (JP) 2022-133888

(51) Int. Cl. B65H 29/60; B65H 5/06; B65H 29/16

(52) U.S. Cl. CPC B65H 29/60; B65H 5/06; B65H 29/16

(57) ABSTRACT

The probability of a conveyed medium becoming jammed is reduced. A switching gate including a plurality of blades that switch a conveyance direction of a medium conveyed by a conveyor belt among a plurality of directions including at least a first direction or a second direction by abutting against the medium, in which the plurality of blades include blades of a blade pair which are disposed at a first distance that is larger than a length of the conveyor belt in a width direction, and blades disposed at a second distance that is smaller than the first distance with respect to the other blades, and the blades of the blade pair disposed at the first distance include an auxiliary blade for reducing a distance between the blades of the blade pair.

### TECHNICAL FIELD

The present invention relates to a switching gate and a medium processing device.

### BACKGROUND ART

In recent years, devices that process various media such as paper sheets have become widespread. One example of such a device is a bill processing device that processes the deposit and withdrawal of bills. Some bill processing devices are equipped with a switching gate that switches a conveyance destination of bills. For example, Patent Literature 1 discloses a switching gate in which a distance between a pair of blades adjacent to a conveyor belt that conveys bills is larger than a distance between another pair of blades.

### CITATION LIST

### Patent Literature

Patent Literature 1: JP 2008-150173A

### SUMMARY OF INVENTION

### Technical Problem

However, in the technology disclosed in Patent Literature 1, there is a concern that the conveyed bills may become jammed between the pair of blades adjacent to the conveyor belt due to the large distance between the pair of blades.

The invention has been made in consideration of the above-described problem, and an object of the invention is to provide a new and improved switching gate and medium processing device which are capable of reducing the probability of a conveyed medium becoming jammed.

### Solution to Problem

To solve the problem, according to an aspect of the present invention, there is provided a switching gate comprising, a plurality of blades that switch a conveyance direction of a medium conveyed by a conveyor belt among a plurality of directions including at least a first direction or a second direction by abutting against the medium, wherein the plurality of blades include blades of a blade pair which are disposed with a first distance therebetween that is larger than a length of the conveyor belt in a width direction, and blades disposed with a second distance therebetween that is smaller than the first distance with respect to the other blades, and the blades of the blade pair disposed at the first distance include an auxiliary blade for reducing a distance between the blades of the blade pair.

Any one of the blades of the blade pair may include the auxiliary blade.

Each of the blades of the blade pair may include the auxiliary blade.

The first direction may be a straight advancing direction of the medium conveyed by the conveyor belt.

The switching gate may further comprise a small blade between the blades of the blade pair to guide the medium conveyed in the second direction.

The auxiliary blade may be provided to reduce a distance between blades of a blade pair positioned such that a positional relationship with the conveyor belt satisfies a predetermined standard.

The auxiliary blade may be provided not to reduce a distance between blades of a blade pair positioned such that a positional relationship with the conveyor belt does not satisfy a predetermined standard.

The position where the positional relationship with the conveyor belt does not satisfy the predetermined standard may be a position where the conveyor belt is interfered with when the distance between the blades of the blade pair is reduced by a predetermine width, and the position where the positional relationship with the conveyor belt satisfies the predetermined standard may be a position where the conveyor belt is not interfered with even when the distance between the blades of the blade pair is reduced by a predetermine width.

The auxiliary blade may be provided to continuously reduce the distance between the blades of the blade pair.

The position where the positional relationship with the conveyor belt does not satisfy the predetermined standard may be a tip side of the blade pair, and the position where the positional relationship with the conveyor belt satisfies the predetermined standard may be a base side of the blade pair.

A conveyance roller may be disposed in the second direction to apply a conveyance force to the medium conveyed in the second direction, and the auxiliary blade may be provided such that a distance between the blades of the blade pair at a position close to the conveyance roller is smaller than a distance between the blades of the blade pair at a position far from the conveyance roller.

The medium may include a bill.

Also, to solve the problem, according to other aspect of the present invention, there is provided a switching gate comprising a plurality of blades that switch a conveyance direction of a medium conveyed by a conveyor belt among a plurality of directions including at least a first direction or a second direction by abutting against the medium, wherein the plurality of blades include blades of a blade pair which are disposed at a first distance that is larger than a length of the conveyor belt in a width direction, and blades disposed at a second distance that is smaller than the first distance with respect to the other blades, and the blades of the blade pair disposed at the first distance are shaped such that a distance therebetween is reduced at positions that do not interfere with the conveyor belt.

Also, to solve the problem, according to other aspect of the present invention, there is provided a medium processing device comprising a switching gate that includes a plurality of blades that switch a conveyance direction of a medium conveyed by a conveyor belt among a plurality of directions including at least a first direction or a second direction by abutting against the medium, wherein the plurality of blades include blades of a blade pair which are disposed at a first distance that is larger than a length of the conveyor belt in a width direction, and blades disposed at a second distance that is smaller than the first distance with respect to the other blades, and the blades of the blade pair disposed at the first distance include an auxiliary blade for reducing a distance between the blades of the blade pair.

Also, to solve the problem, according to other aspect of the present invention, there is provided a medium processing device comprising a switching gate that includes a plurality of blades that switch a conveyance direction of a medium conveyed by a conveyor belt among a plurality of directions including at least a first direction or a second direction by abutting against the medium, wherein the plurality of blades include blades of a blade pair which are disposed at a first distance that is larger than a length of the conveyor belt in a width direction, and blades disposed at a second distance that is smaller than the first distance with respect to the other blades, and the blades of the blade pair disposed at the first distance are shaped such that a distance therebetween is reduced at positions that do not interfere with the conveyor belt.

### Advantageous Effects of Invention

As described above, according to the invention, it is possible to reduce the probability of a conveyed medium becoming jammed.

### BRIEF DESCRIPTION OF DRAWINGS

FIG. 1 is a diagram showing an example of the appearance of a cash register change system according to an embodiment of the invention.

FIG. 2 is a left side view showing the internal configuration of a bill deposit/withdrawal device.

FIG. 3 is a diagram showing an example of the configuration of a branch part vicinity.

FIG. 4 is a diagram showing an example of the structure of a switching gate.

FIG. 5 is a diagram showing an example of a top view of the branch part vicinity including the switching gate.

FIG. 6 is a diagram showing an example of the structure of a switching gate according to an embodiment of the invention.

FIG. 7 is a diagram showing an example of a top view of the branch part vicinity including the switching gate.

FIG. 8 is an enlarged view of a region in the top view shown in FIG. 7.

### DESCRIPTION OF EMBODIMENTS

A preferred embodiment of the invention will be described in detail below with reference to the accompanying drawings. In this specification and drawings, components having substantially the same functional configuration are denoted by the same reference numerals, and a repeated description will be omitted.

### 1. Overview of Cash Register Change System

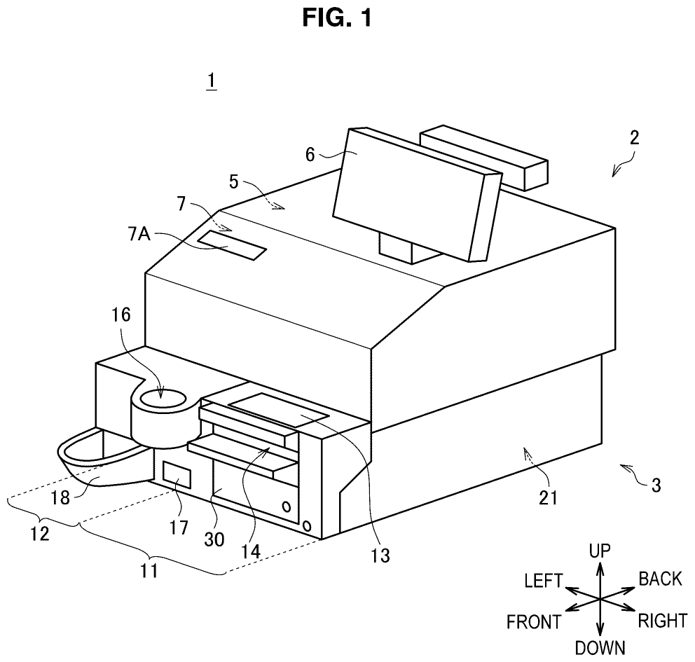

One embodiment of the invention relates to a cash register change system that can reduce the probability of a conveyed medium becoming jammed. First, an overview of the cash register change system will be described with reference to FIG. 1.

### <1.1. Configuration Example of Cash Register Change System>

FIG. 1 is a diagram showing an example of the appearance of a cash register change system 1 according to an embodiment of the invention. The cash register change system 1 is a device that processes various media such as paper sheets, coins, and cards. In addition, the media include bills, gold notes such as gift certificates, tickets, slips, and the like. In the following description, an example in which a medium is a bill will be mainly described.

The cash register change system 1 is a settlement machine that is operated by a cashier in a settlement place (so-called cash register) in a retail store such as a supermarket or a convenience store when a customer pays for a product that he or she desires to purchase.

For example, the cash register change system 1 may be a semi-self-service change machine operated by a customer at a retail store. However, the cash register change system 1 is not limited to a semi-self-service change machine. For example, the cash register change system 1 may be a self-service change machine.

As shown in FIG. 1, the cash register change system 1 includes a point of sales (POS) cash register 2 and a change machine 3. The POS cash register 2 and the change machine 3 may be independent devices or may be an integrated device.

In the following description, the side surface of the cash register change system 1 that a cashier (hereinafter also referred to as a user) faces will be referred to as a front face, and the opposite surface will be referred to as a rear face. In addition, description will be given on the assumption that a right-left direction and an up-down direction are directions seen from the user.

### <1.2. POS Cash Register 2>

As shown in FIG. 1, the POS cash register 2 according to this embodiment includes a cash register control unit 5, an operation display unit 6, a receipt processing unit 7, and a receipt discharge opening 7A. The arrangement of the components of the POS cash register 2 is not limited to the example shown in FIG. 1.

The cash register control unit 5 according to this embodiment controls the overall operation of the POS cash register 2. The cash register control unit 5 is built into the POS cash register 2.

In addition, a barcode reader (not shown) is connected to the POS cash register 2, and various information such as the name and price of a product is recognized by reading a barcode attached to the product with the barcode reader.

The operation display unit 6 according to this embodiment functions as a display unit that displays the name and price of the product which are recognized by the barcode reader.

In addition, the operation display unit 6 displays input keys such as numbers on a part of a display screen, and when a part corresponding to the input key is pressed by the user, the operation display unit 6 functions as an operation unit that receives an input operation corresponding to the input key.

The function as a display unit can be realized by a cathode ray tube (CRT) display device, a liquid crystal display (LCD), or an organic light emitting diode (OLED) device. In addition, the function as an operation unit can be realized by, for example, a touch panel or a keyboard. The function as the display unit and the function as the operation unit may be configured separately.

In addition, the operation display unit 6 outputs information that has been received through the input operation to the cash register control unit 5. The cash register control unit 5 then performs various processing such as increasing or decreasing the number of products and correcting a price in accordance with the information input from the operation display unit 6.

The receipt processing unit 7 according to this embodiment prints the name and price of the product which are recognized by the barcode reader on a receipt. The receipt discharge opening 7A discharges the receipt printed by the receipt processing unit 7. In addition, the receipt processing unit 7 is built into the POS cash register 2.

### <1.3. Change Machine>

As shown in FIG. 1, the change machine 3 according to this embodiment includes a bill deposit/withdrawal device 11, a coin deposit/withdrawal device 12, an operation display unit 13, and a change control unit 21.

FIG. 1 shows an example in which the bill deposit/withdrawal device 11 is disposed on the right side, the coin deposit/withdrawal device 12 is disposed on the left side, and the operation display unit 13 is disposed on the upper front side, but the arrangement of the components is not limited to such an example.

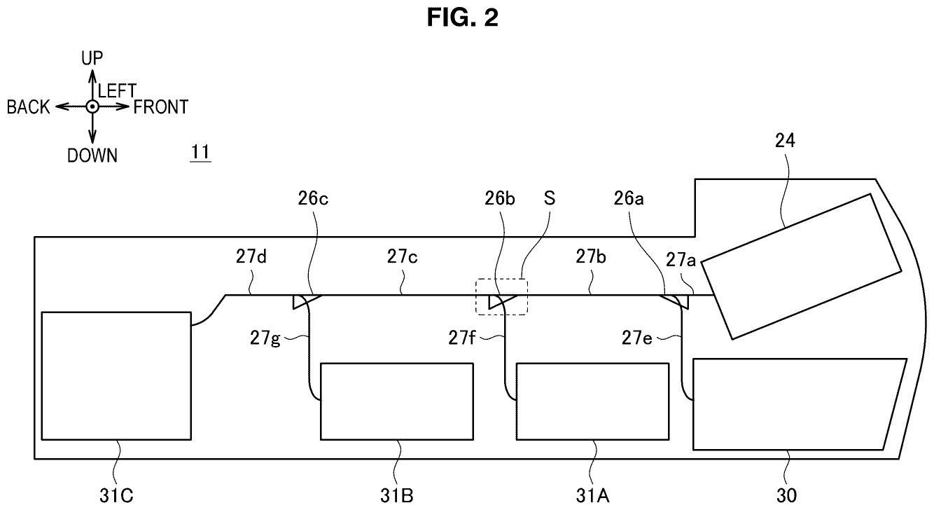

The bill deposit/withdrawal device 11 according to this embodiment is an example of a medium processing device, and takes in bills inserted into a bill deposit/withdrawal slot 14 by the user and stores the bills in a bill storage (details will be described later with reference to FIG. 2).

The bill deposit/withdrawal device 11 also delivers bills corresponding to the denomination and number according to an amount of money instructed by the cash register control unit 5 from the bill storage, and withdraws the bills from the bill deposit/withdrawal slot 14 as change.

The coin deposit/withdrawal device 12 according to this embodiment takes in coins inserted into a coin deposit port 16 by the user and stores the coins in a coin storage.

Further, the coin deposit/withdrawal device 12 delivers coins corresponding to the denomination and number according to an amount of money instructed by the cash register control unit 5 from the coin storage, and withdraws the coins from a coin withdrawal slot 18 as change.

As shown in FIG. 1, the coin deposit port 16 is provided at an upper stage on the front side of the coin deposit/withdrawal device 12, and a reject port 17 and the coin withdrawal slot 18 may be provided below the coin deposit port 16.

The operation display unit 13 according to this embodiment is constituted by a combination of a predetermined display panel and predetermined operation buttons.

For example, the display panel of the operation display unit 13 has a function as a display unit that displays the operating status in the bill deposit/withdrawal device 11 and the coin deposit/withdrawal device 12. The display panel of the operation display unit 13 also displays, for example, that the coin deposit/withdrawal device 12 is short of coins for change, that a predetermined sensor has detected an abnormality, and the location where the abnormality has been detected.

In addition, the operation buttons on the operation display unit 13 function as operation units that receive instructions related to, for example, conveyance of coins through a user's pressing operation.

The function as the display unit can be realized by a CRT display device, a liquid crystal display (LCD), or an OLED device. In addition, the function as the operation unit can be realized by, for example, a touch panel or a keyboard. The function as the display unit and the function as the operation unit may be configured separately.

The change control unit 21 controls the overall operation of the change machine 3. The change control unit 21 is built into the change machine 3. The change control unit 21 is mainly constituted by a central processing unit (CPU) (not shown), and reads and executes various programs from a memory such as a flash memory to perform the overall control of the change machine 3 and perform various processing such as deposit transactions and withdrawal transactions.

The overview of the cash register change system 1 according to this embodiment has been described above. Next, an example of the internal configuration of the bill deposit/withdrawal device 11 will be described with reference to FIG. 2.

### 2. Example of Internal Configuration of Bill Deposit/Withdrawal Device 11

FIG. 2 is a left side view showing the internal configuration of the bill deposit/withdrawal device 11. The bill deposit/withdrawal device 11 has various internal components related to conveyance and storage of bills inside. A specific example of a flow after bills are inserted into the bill deposit/withdrawal slot 14 shown in FIG. 1 in deposit processing will be described below.

First, the bills inserted into the bill deposit/withdrawal slot 14 shown in FIG. 1 are accumulated in a delivery accumulation unit 24 as shown in FIG. 2. The delivery accumulation unit 24 takes in the bills inserted by a user, separates the bills one by one, and delivers the bills to a conveyance path 27a.

Then, the bills delivered to the conveyance path 27a are stored in a collection cassette 30 or a bill storage 31.

The collection cassette 30 is a bill storage that is used to collect the bills stored in the bill storage 31 on the outer side of the bill deposit/withdrawal device 11 and to store and collect bills that are determined to be unsuitable for withdrawal by a discrimination unit (not shown). The bills that are determined to be unsuitable for withdrawal by the discrimination unit are, for example, 2,000 yen bills and old bills that can be used as bills in deposit processing but are not recycled and cannot be used for withdrawal, and are, for example, withdrawal-rejected bills that are delivered from the bill storage 31 in withdrawal processing but determined to be in poor condition by the discrimination unit.

The bill storage 31 includes, for example, a bill storage 31A for storing 1,000 yen bills, a bill storage 31B for storing 5,000 yen bills, and a bill storage 31C for storing 10,000 yen bills. However, the denominations corresponding to the bill storages 31A to 31C are not limited to such an example. For example, a 10,000 yen bill may be stored in the bill storage 31A, and a 1,000 yen bill may be stored in the bill storage 31C.

In addition, the conveyance direction of the bills conveyed through conveyance paths 27 is switched by switching gates 26 (26a to 26c) provided at a plurality of locations along the conveyance paths 27. For example, the switching gate 26a rotates to switch the conveyance direction of bills conveyed through a conveyance path 27a to a straight conveyance path 27b or a downward conveyance path 27e. The bills conveyed to the downward conveyance path 27e are stored in the collection cassette 30.

In addition, the switching gate 26b switches the conveyance direction of bills conveyed through the conveyance path 27b to a straight conveyance path 27c or a downward conveyance path 27f. The bills conveyed to the downward conveyance path 27f are stored in the bill storage 31A.

In addition, the switching gate 26c switches the conveyance direction of bills conveyed through the conveyance path 27c to a straight conveyance path 27d or a downward conveyance path 27g. The bills conveyed to the downward conveyance path 27g are stored in the bill storage 31B. In addition, the bills conveyed to the straight conveyance path 27d are stored in the bill storage 31C.

As described above, bills inserted into the bill deposit/withdrawal slot 14 are stored in the collection cassette 30 or in the bill storages 31 (31A to 31C) corresponding to denominations via the plurality of conveyance paths 27 (27a to 27g) and the plurality of switching gates 26 (26a to 26c).

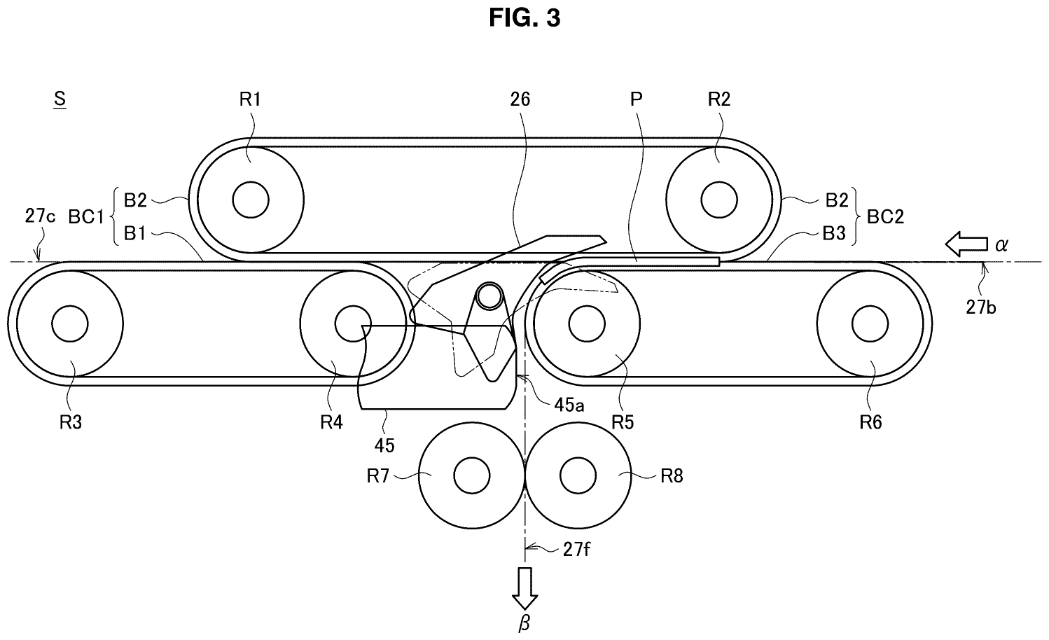

Next, a configuration of a branch part vicinity S, which is the vicinity of the switching gate 26b as a branching point where a conveyance direction of bills is switched, will be described with reference to FIG. 3.

### 3. Overview of Branch Part Vicinity S

### <3.1. Example of Configuration of Branch Part Vicinity S>

FIG. 3 is a diagram showing an example of a configuration of the branch part vicinity S. In FIG. 3, an example of a configuration of the vicinity of the switching gate 26b that switches the conveyance direction of bills conveyed through the conveyance path 27b to the conveyance path 27c or the conveyance path 27f is described. However, the switching gates 26a to 26c are regarded as having the same characteristics (for example, a shape, a size, and the like), and the switching gate 26b may be simply referred to as a switching gate 26.

As shown in FIG. 2, in the branch part vicinity S, for example, rollers R1 to R8 are provided at eight locations in a side view.

More specifically, in a side view as shown in FIG. 3, the roller R2 is disposed on the right side of the roller R1, and the roller R3 is disposed on the lower left side of the roller R1. Furthermore, the roller R4 is disposed at a position on the lower right side of the roller R1 and on the right side of the roller R3.

Furthermore, the roller R5 is disposed at a position on the lower left side of the roller R2 and on the right side of the roller R4, and the roller R6 is disposed at a position on the lower right side of the roller R2 and on the right side of the roller R5.

Furthermore, the rollers R7 and R8 are disposed side by side below the roller R5.

In FIG. 3, only rollers on the front side of the drawing are shown as the rollers R1 to R8, but actually, rollers are also provided one by one on the back side thereof. That is, in the branch part vicinity S, the rollers R1 to R8 are provided at eight positions in a side view, two each on the front and back sides, that is, along a right-left width direction of the bill deposit/withdrawal device 11.

Furthermore, a belt B2 is attached to a pair of rollers R1 and R2, a belt B1 is attached to a pair of rollers R3 and R4, and a belt B3 is attached to a pair of rollers R5 and R6. Regarding the belts B1 to B3, only the belts attached to the rollers on the front side are shown in FIG. 3, but actually, the belts B1 to B3 are also attached to the rollers R1 to R6 on the back side.

The belts B1 and B2 form a belt pair BC1 that holds a bill P therebetween. In addition, the belts B2 and B3 form a belt pair BC2 that holds a bill P therebetween. These belt pairs BC1 and BC2 are parts of the conveyance paths 27b and 27c that convey bills in the direction of an arrow α (direction from right to left in FIG. 3). Also, regarding the belt pairs BC1 and BC2, a total of two belt pairs are provided respectively on the front side and on the back side, and the belt pair BC1 (or BC2) on the front side and the belt pair BC1 (or BC2) on the back side convey the bill P by holding it at two locations, that is, one end side and the other end side in the longitudinal direction thereof.

The switching gate 26 that switches the conveyance direction of bills is rotatably supported between the rollers R4 and R5.

When the switching gate 26 is located at a position indicated by a solid line in FIG. 3, the switching gate 26 guides the bill P conveyed by the belt pair BC2 in the direction of an arrow β (downward) that is substantially perpendicular to the direction of the arrow α and conveys the bill P toward the conveyance path 27f passing between the rollers R7 and R8. The direction of the arrow α is an example of a first direction, and the direction of the arrow β is an example of a second direction.

Furthermore, a conveyance guide 45 that continuously guides the bill P guided and conveyed in the direction of the arrow β by the switching gate 26 to the vicinity of the roller R7 is provided between the switching gate 26 and the roller R7.

The conveyance guide 45 has a guide surface 45a parallel to the direction of the arrow β (that is, parallel to the conveyance path 27f), and the bill P is guided in the direction of the arrow β along this guide surface 45a. The bill guided along the guide surface 45a receives a conveyance force from the rollers R7 and R8 and is conveyed in the direction of the arrow β (that is, the conveyance path 27f).

On the other hand, when the switching gate 26 is located at a position indicated by in the position shown by an alternating two dots-dashed line in FIG. 3, the switching gate 26 guides the bill P, which has been conveyed in the direction of the arrow α by the belt pair BC2, as it is linearly in the direction of the arrow α (that is, in a straight advancing direction) and conveys it toward the belt pair BC1.

The branch part vicinity S allows bidirectional conveyance of the bill P. That is, the change control unit 21 can rotate the switching gate 26 to the position indicated by the solid line in FIG. 3 and guide the bill P conveyed along the conveyance path 27f in a direction opposite to the arrow β (that is, a direction from bottom to top in FIG. 3) in a direction opposite to the arrow α (that is, from left to right in FIG. 3) to conveyance it toward the conveyance path 27b, or can rotate the switching gate 26 to the position indicated by the alternating two dots-dashed line in FIG. 3 and guide the bill P conveyed by the belt pair BC1 in the direction opposite to the arrow α as it is in the direction opposite to the arrow α to conveyance it toward the belt pair BC2.

As described above, the switching gate 26 switches the conveyance direction of the bill P conveyed by the belt pairs BC1 and BC2 to include the a direction and the β direction by abutting against the bill P.

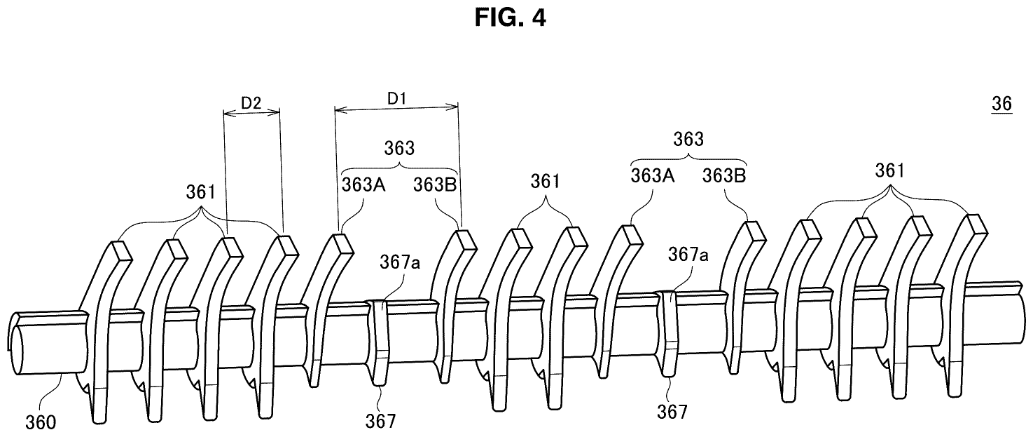

Here, in order to clarify the problems with the switching gate 26 according to the embodiment of the invention, a switching gate 36 having a structure partially different from the structure of the switching gate 26 according to the embodiment of the invention will be described with reference to FIG. 4.

### <3.2. Example of Structure of Switching Gate 36>

FIG. 4 is a diagram showing an example of the structure of the switching gate 36. The switching gate 36 includes a plurality of blades as shown in FIG. 4.

More specifically, the switching gate 36 includes a shaft 360, a first blade 361, and second blades 363A and 363B.

The first blade 361 is provided to be fixed to the shaft 360. The first blade 361 is a blade that is provided such that a distance between adjacent blades is a second distance D2. In the example shown in FIG. 4, the switching gate 36 includes ten first blades 361. However, the number of first blades 361 included in the switching gate 36 is not limited to ten.

For example, the first blade 361 is provided in the switching gate 36 so that a distance between the two first blades 361 is the second distance D2. In addition, the first blade 361 is provided in the switching gate 36 so that a distance between the first blade 361 and a second blade 363A (or a second blade 363B) is the second distance D2.

The second blades 363A and 363B are provided to be fixed to the shaft 360. In addition, the second blades 363A and 363B are blades located adjacent to the belt B2 (FIG. 3). A blade pair 363 of the second blade 363A and the second blade 363B needs to be provided in the switching gate 36 so as not to interfere with the belt B2. As a result, the second blades 363A and 363B are provided in the switching gate 36 so that the distance between the blades of the blade pair 363 is a first distance DI which is wider than the second distance D2. Further, in the example shown in FIG. 4, the switching gate 36 includes two second blades 363A and two second blades 363B, but the number of each of the second blades 363A and 363B included in the switching gate 36 is not limited to two.

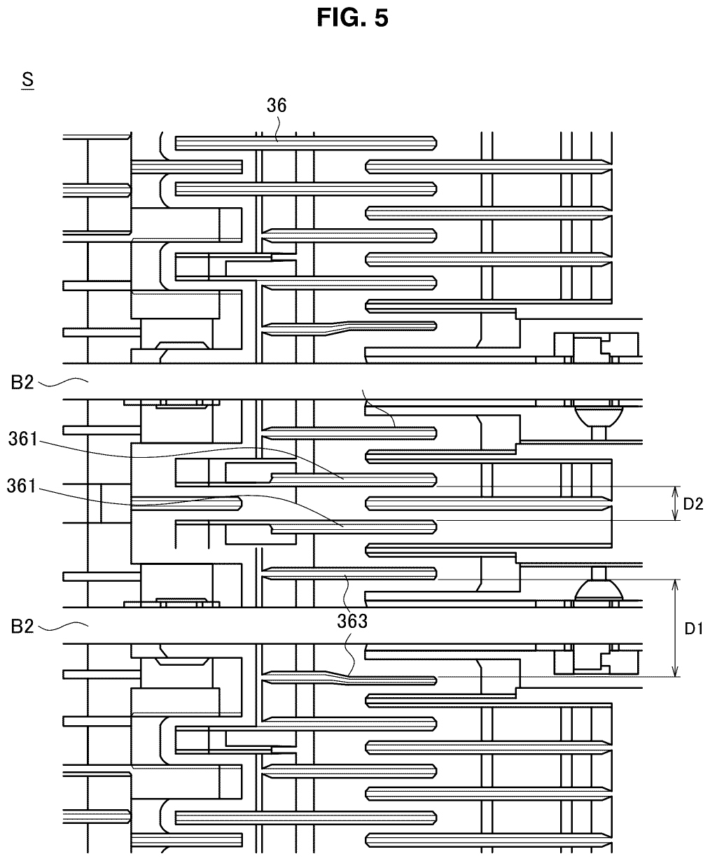

FIG. 5 is a diagram showing an example of a top view of the branch part vicinity S including the switching gate 36. Out of the two belts B2 shown in FIG. 5, the belt B2 on the upper side in FIG. 5 is the belt B2 on the back side in the branch part vicinity S shown in FIG. 3, and the belt B2 on the lower side in FIG. 5 is the belt B2 on the front side in the branch part vicinity S shown in FIG. 3.

For example, among the plurality of blades included in the switching gate 36, the blades of the blade pair 363 positioned adjacent to the belt B2 are disposed at the first distance D1 that is larger than the length in the width direction of a structure (hereinafter referred to as a conveyor belt) including the belt B2. Thereby, the blade pair 363 does not interfere with the conveyor belt.

Furthermore, among the plurality of blades included in the switching gate 36, the blades of the blade pair including the first blade 361 that is not positioned adjacent to the belt B2 are disposed at the second distance D2 that is smaller than the first distance D1.

In this manner, the distance (that is, the first distance D1) between the blades of the blade pair 363 adjacent to the conveyor belt is larger than the distance (that is, the second distance D2) between the blades of the blade pair including the first blade 361 that is not adjacent to the conveyor belt because it is necessary to prevent the blade pair from interfering with the conveyor belt.

When a bill has a crease or cut, there is a concern that the crease or cut part of the bill will get caught in a gap between the blades when the bill is conveyed. When the crease or cut part of the bill gets caught in the gap between the blades, the bill may become jammed. For this reason, it is desirable to reduce a distance between the blades to a certain extent so that the crease or cut part of the bill does not get caught in a gap between the blades.

For this reason, the first blade 361 is disposed such that the distance between the blades is reduced to a certain extent, and the distance between the blades of the blade pair including the first blade 361 positioned not adjacent to the belt B2 is the second distance D2. On the other hand, as described above, since the conveyor belt is provided between the blades of the blade pair 363, it is difficult to dispose the blade pairs 363 so that the distance between the blades of the blade pair 363 is a distance (that is, the second distance D) that is smaller than the conveyor belt.

Consequently, the switching gate 36 may further have a small blade 367 (FIG. 4) that guides a bill so that the distance between the blades of the blade pair 363 is not excessively large. More specifically, as shown in FIG. 4, the switching gate 36 includes a small blade 367 between the blades of the blade pair 363 adjacent to the conveyor belt.

The small blade 367 has a small blade-like structure as shown in FIG. 4 so as not to interfere with the conveyor belt. When the bill P enters between the blades of the blade pair 363, the bill P collides with an inclined portion 367a of the small blade 367 and is guided in the direction of the arrow β shown in FIG. 3.

However, since the small blade 367 is shaped not to interfere with other parts such as the conveyor belt, the amount of intrusion of the tip of the small blade 367 (for example, an adjacent side of a right-angled triangle with the inclined portion 367a as a hypotenuse) may become small, or the angle of attack with respect to the bill P may become large. Thereby, the bill P may bend in a direction different from the direction in which the small blade 367 should guide the bill, and the bill P may get caught on the small blade 367, resulting in a concern that the bill P may become jammed in the switching gate 36.

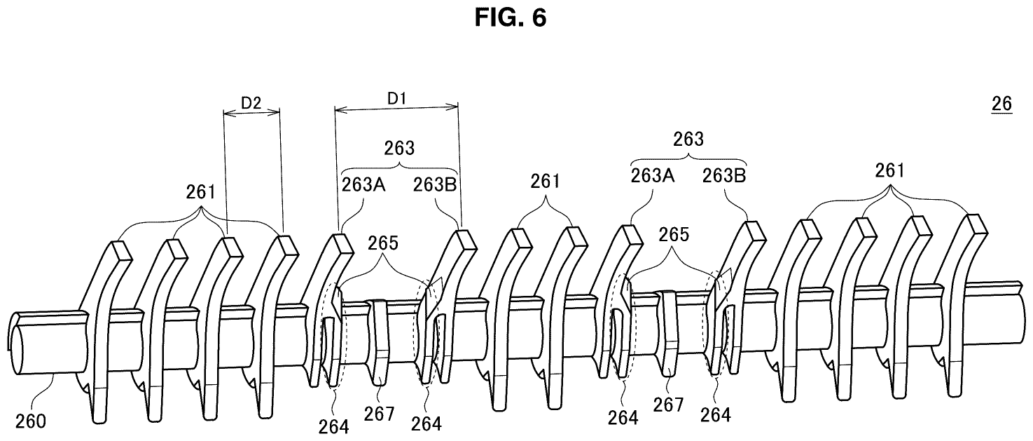

Here, the switching gate 26 according to the embodiment of the invention is intended to solve such problems and is characterized by having a shape that can further prevent the bill P from becoming jammed. Hereinafter, an example of the structure of the switching gate 26 according to the embodiment of the invention will be described with reference to FIG. 6.

### 4. Example of Structure of Switching Gate 26 According to Embodiment of Invention

FIG. 6 is a diagram showing an example of the structure of the switching gate 26 according to the embodiment of the invention. As shown in FIG. 6, the switching gate 26 according to the embodiment of the invention includes a shaft 260, a first blade 261, second blades 263A and 263B, and a small blade 267.

In addition, a blade pair 263 of the second blades 263A and 263B according to the embodiment of the invention includes auxiliary blades 264 as shown in FIG. 6. A configuration of the switching gate 26 other than the auxiliary blades 264 is the same as that of the switching gate 36, and thus the description thereof will be omitted here.

The auxiliary blade 264 is provided to be fixed to the shaft 260 or the second blades 263A and 263B. The auxiliary blades 264 are provided between the second blades 263A and 263B so that a distance between the auxiliary blades 264 is smaller than a first distance D1 between the blades of the blade pair 263.

In other words, a distance between the tip sides of the second blades 263A and 263B is the first distance D1, but the first distance DI is reduced due to the auxiliary blades 264 toward the base sides of the second blades 263A and 263B which are fixed to the shaft 260.

As described above in FIG. 3, the switching gate 26 is rotated at a plurality of angles, and thus the tip sides of the second blades 263A and 263B are prevented from interfering with the belt B2 due to the first distance D1, while a distance between the base sides of the second blades 263A and 263B is smaller than the first distance D1 because they do not interfere with the belt B2 regardless of the rotation angle of the switching gate 26.

Conditions for the positions of the auxiliary blades 264 disposed between the blades of the blade pair 263 will be described. For example, the auxiliary blades 264 may be provided to reduce the distance between the blades of the blade pair 263 positioned such that a positional relationship with the conveyor belt satisfies a predetermined standard.

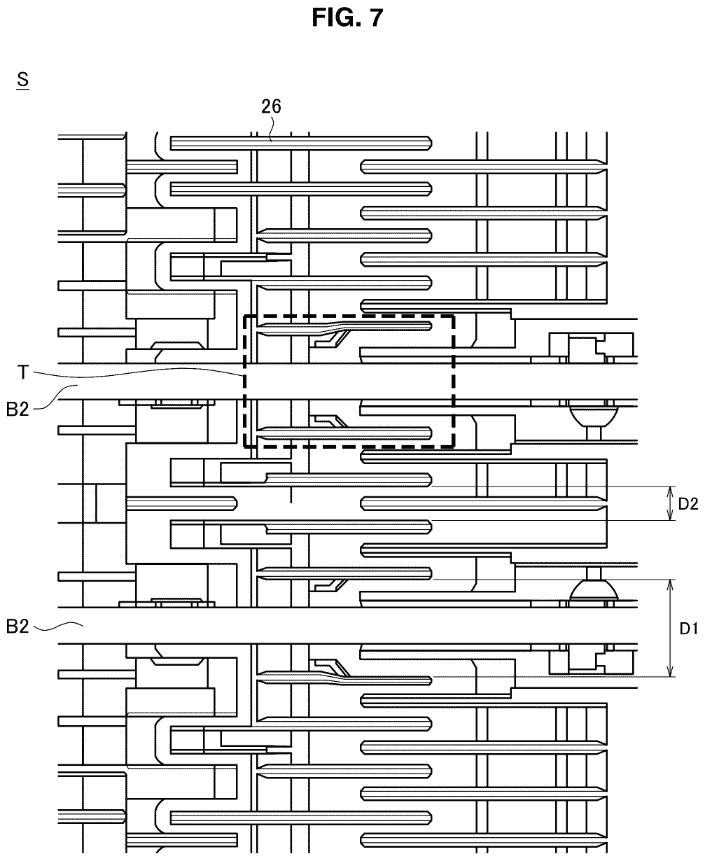

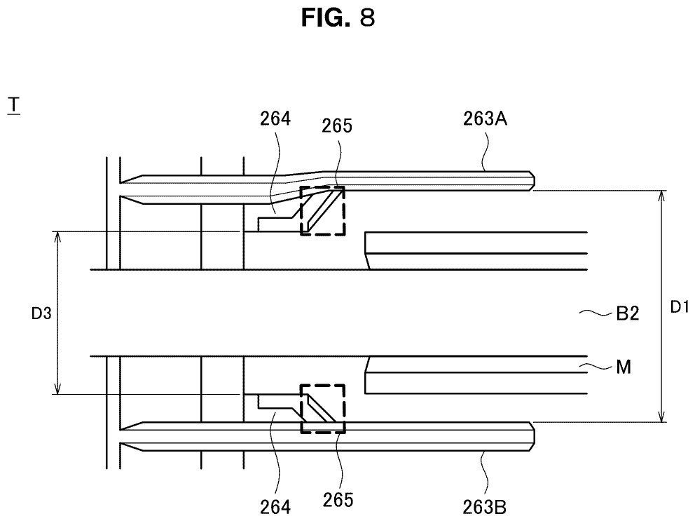

On the other hand, the auxiliary blades 264 may be provided not to reduce the distance between the blades of the blade pair 263 positioned such that a positional relationship with the conveyor belt does not satisfy a predetermined standard. Hereinafter, a specific example of a criterion for determining whether a positional relationship between the blade pair 263 and the conveyor belt satisfies a predetermined standard when the auxiliary blades 264 are provided will be described with reference to FIGS. 7 and 8.

FIG. 7 is a diagram showing an example of a top view of the branch part vicinity S including the switching gate 26. FIG. 7 is a diagram in which the switching gate 36 is replaced with the switching gate 26 in the branch part vicinity S shown in FIG. 5.

Here, a region T shown in FIG. 7 includes the area around the blade pair 263 and the auxiliary blade 264.

FIG. 8 is an enlarged view of the region T in the top view shown in FIG. 7. In an example shown in FIG. 8, description will be given on the assumption that the conveyor belt is a structure including the belt B2 and a support portion M that supports the belt B2.

Similarly to the small blade 267, the auxiliary blades 264 need to be provided in the blade pair 263 so as not to interfere with the conveyor belt. Consequently, a condition for the position of the auxiliary blade 264 disposed at the second blade 263A (263B) is whether the position makes it possible to reduce the distance between the second blade 263A (263B) and the conveyor belt. This can be said as whether a positional relationship between the blade pair 263 and the conveyor belt satisfies a predetermined standard.

For example, a position where a positional relationship with the conveyor belt satisfies a predetermined standard may be a position where the conveyor belt is not interfered with even when a distance between the blades of the blade pair 263 is reduced by a predetermined value or more.

In addition, a position where the positional relationship with the conveyor belt does not satisfy the predetermined standard may be a position where the blade pair 263 is interfered with when a distance between the blades of the blade pair 263 is reduced by a predetermined value or more.

For example, in the example shown in FIG. 8, even when the distance between the blades of the blade pair 263 is reduced by a predetermined width by the auxiliary blades 264 on the base side of the blade pair 263, the blade pair 263 does not interfere with the conveyor belt. In this case, the base side of the blade pair 263 that does not interfere with the conveyor belt when the distance between the blades of the blade pair 263 is reduced by a predetermined width may be a position where the positional relationship with the conveyor belt satisfies a predetermined standard.

On the other hand, when a distance between the blades of the blade pair 263 is reduced by the predetermined width by the auxiliary blades 264 on the tip side of the blade pair 263, the blade pair 263 interferes with the support portion M supporting the belt B2. In this case, when the distance is reduced by the predetermined width, the tip side of the blade pair 263 that interferes with the conveyor belt may be set as a position where a positional relationship with the conveyor belt does not satisfy the predetermined standard.

Consequently, the auxiliary blade 264 is provided at a position in the second blade 263A (263B) which does not interfere with the conveyor belt (belt B2 or support portion M), thereby reducing the distance between the blades of the blade pair 263 to a third distance D3.

As described above, the position in the second blade 263A (263B) which does not interfere with the conveyor belt (belt B2 or support portion M) is the base side of the blade pair 263. Thereby, the distance between the blades of the blade pair 263 on the base side is smaller than the first distance D1 on the tip side of the blade pair 263 by the auxiliary blades 264. In this manner, the switching gate 26 according to the embodiment of the invention can reduce the probability of a bill becoming jammed when the bill moves toward the base side of the blade pair 263 while preventing the blade pair 263 from interfering with the conveyor belt (belt B2 or support portion M).

In addition, the auxiliary blades 264 may be provided to continuously reduce the distance between the blades of the blade pair 263 from the tip side to the base side of the blade pair 263. For example, one end of the auxiliary blade 264 may be connected to the vicinity of the center of the second blade 263A (263B), and the distance may be gradually reduced toward the base side of the second blade 263A (263B) with the connection point as a starting point.

Thereby, an inclined portion 265 is formed at a connection point between the second blade 263A (263B) and the auxiliary blade 264, and the side surface of the second blade 263A (263B) and the side surface of the auxiliary blade 264 are continuously connected to each other without any step by the inclined portion 265. In this manner, since a bill is conveyed along the inclined portion 265, it is possible to prevent the bill from being crushed on the base side of the blade pair 263.

In addition, the auxiliary blade 264 may be provided on the basis of a distance between conveyance rollers (rollers R7 and R8) and the blade pair 263 included in the branch part vicinity S shown in FIG. 3. Specifically, the auxiliary blade 264 may be provided such that a distance between the blades of the blade pair 263 at a position close to the conveyance rollers (rollers R7 and R8) is smaller than a distance between the blades of the blade pair 263 at a position far from the conveyance rollers included in the branch part vicinity S shown in FIG. 3. For example, the auxiliary blade 264 may be provided to reduce the distance between the blades of the blade pair 263 on the rollers R7 and R8 side, rather than reducing the distance between the blades of the blade pair 263 on the belt B2 side shown in FIG. 3.

By providing the auxiliary blades 264 on the basis of the distance between the conveyance rollers (rollers R7, R8) and the blade pair 263, the switching gate 26 according to the embodiment of the invention can reduce the probability of a defect occurring in the conveyance of a bill when the bill moves toward the base side of the blade pair 263 and is transferred to the conveyance rollers (rollers R7 and R8) while preventing the blade pair 263 from interfering with the conveyor belt (belt B2 or support portion M).

### 5. Supplement

The preferred embodiment of the invention has been described above in detail with reference to the accompanying drawings, but the invention is not limited to such examples. It would be apparent for those skilled in the technical field to which the invention belongs that various modification examples or correction examples are conceivable within the scope of the technical idea recited in the claims, and it would be understood that these fall within the technical scope of the invention.

For example, the switching gate 26 according to the embodiment of the invention preferably include the small blade 267 to reduce a distance between the blades of the blade pair 263, but does not necessarily need to include the small blade 267 because a predetermined distance is reduced by the auxiliary blades 264.

Further, in this specification, an example in which the belt B2 is attached to the pair of rollers R1 and R2, the belt B1 is attached to the pair of rollers R3 and R4, and the belt B3 is attached to the pair of rollers R5 and R6 has been mainly described. However, all of the belts B1 to B3 do not necessarily need to be attached to the rollers R1 to R6. For example, when the belt B2 is attached to the pair of rollers R1 and R2, the belt B1 does not need to be attached to the pair of rollers R3 and R4.

Further, in this specification, an example in which the conveyance direction of bills is two directions, that is, the direction of the arrow α and the direction of the arrow β has been mainly described, but the conveyance direction of bills may be three or more directions. Furthermore, the directions of the arrow α and the arrow β are not limited to the straight advancing direction or downward direction of bills. For example, the direction of the arrow α may be an upward direction, and the direction of the arrow β may be a backward direction.

Further, in this specification, a case where the invention is applied to the change machine 3, which is a settlement machine operated by a cashier. However, the invention is not limited thereto, and the invention may be applied to a self-settlement machine or semi-self-settlement machine operated by a customer himself or herself.

Further, in this specification, a case where the invention is applied to the change machine 3, which is connected to the POS cash register 2 used in a register settlement place of a supermarket, a convenience store, or the like and performs deposit/withdrawal processing of bills and coins, has been described. However, the invention is not limited thereto, and the invention may be applied to various devices, such as automated teller machines (counter terminals) used in banks, which are terminals used by bank employees.

### REFERENCE SIGNS LIST

1 cash register change system
2 POS cash register
3 change machine
5 cash register control unit
6 operation display unit
7 receipt processing unit
7A receipt discharge opening
11 bill deposit/withdrawal device
12 coin deposit/withdrawal device
13 operation display unit
21 change control unit
24 delivery accumulation unit
26 switching gate
260 shaft
261 first blade
263A, 263B second blade
263 blade pair
264 auxiliary blade
265 inclined portion
267 small blade
30 collection cassette
31 bill storage
36 switching gate
360 shaft
361 first blade
363A, 363B second blade
363 blade pair
367 small blade
45 conveyance guide

1. A switching gate comprising:
a plurality of blades that switch a conveyance direction of a medium conveyed by a conveyor belt among a plurality of directions including at least a first direction or a second direction by abutting against the medium, wherein
the plurality of blades include blades of a blade pair which are disposed with a first distance therebetween that is larger than a length of the conveyor belt in a width direction, and blades disposed with a second distance therebetween that is smaller than the first distance with respect to the other blades, and
the blades of the blade pair disposed at the first distance include an auxiliary blade for reducing a distance between the blades of the blade pair.

2. The switching gate according to claim 1, wherein any one of the blades of the blade pair include the auxiliary blade.

3. The switching gate according to claim 1, wherein each of the blades of the blade pair include the auxiliary blade.

4. The switching gate according to claim 3, wherein the first direction is a straight advancing direction of the medium conveyed by the conveyor belt.

5. The switching gate according to claim 4, further comprising a small blade between the blades of the blade pair to guide the medium conveyed in the second direction.

6. The switching gate according to claim 5, wherein the auxiliary blade is provided to reduce a distance between blades of a blade pair positioned such that a positional relationship with the conveyor belt satisfies a predetermined standard.

7. The switching gate according to claim 6, wherein the auxiliary blade is provided not to reduce a distance between blades of a blade pair positioned such that a positional relationship with the conveyor belt does not satisfy a predetermined standard.

8. The switching gate according to claim 7, wherein
the position where the positional relationship with the conveyor belt does not satisfy the predetermined standard is a position where the conveyor belt is interfered with when the distance between the blades of the blade pair is reduced by a predetermine width, and
the position where the positional relationship with the conveyor belt satisfies the predetermined standard is a position where the conveyor belt is not interfered with even when the distance between the blades of the blade pair is reduced by a predetermine width.

9. The switching gate according to claim 8, wherein the auxiliary blade is provided to continuously reduce the distance between the blades of the blade pair.

10. The switching gate according to claim 8, wherein
the position where the positional relationship with the conveyor belt does not satisfy the predetermined standard is a tip side of the blade pair, and
the position where the positional relationship with the conveyor belt satisfies
